(19) United States
(12) Patent Application Publication
(10) Pub. No.: US 2026/0364446 A1
(43) Pub. Date: Nov. 19, 2026

(54) METHOD, APPARATUS, DEVICE, MEDIUM AND PRODUCT FOR PROCESSING VIDEO STREAM

(71) Applicant: Beijing Zitiao Network Technology Co., Ltd., Beijing (CN)

(72) Inventors: Wenxuan ZHANG, Beijing (CN); Guangyuan FENG, Beijing (CN); Feng ZHOU, Beijing (CN); Bang PENG, Beijing (CN); Jingchao LIU, Beijing (CN); Jiehua ZHU, Beijing (CN); Yu YANG, Beijing (CN); Sheng WANG, Beijing (CN)

(21) Appl. No.: 19/676,705

(22) Filed: May 13, 2026

(30) Foreign Application Priority Data
May 14, 2025 (CN) 202510622063.9

(51) Int. Cl. A63F 13/355; A63F 13/52; A63F 13/86; H04N 21/2187; H04N 21/234; H04N 21/242; H04N 21/266

(52) U.S. Cl. CPC A63F 13/355; A63F 13/52; A63F 13/86; H04N 21/2187; H04N 21/23424; H04N 21/242; H04N 21/266

(57) ABSTRACT

Embodiments of the present disclosure relate to a method, an apparatus, a device, a medium, and a product for processing a video stream. The method includes: sending, in response to a user starting a cloud game for live streaming at a live streaming end, a cloud game video stream for the cloud game to the live streaming end via a first transmission channel, the cloud game video stream including a cloud game video frame and an identifier of the cloud game video frame; receiving a live streaming video stream for the live streaming end via a second transmission channel, a live streaming video frame in the live streaming video stream being associated with the identifier; combining the cloud game video frame and the live streaming video frame based on the identifier to generate a combined video stream; and sending the combined video stream for live streaming of the cloud game.

### CROSS-REFERENCE TO RELATED APPLICATION(S)

This application claims priority to Chinese Application No. 202510622063. 9 filed on May 14, 2025, the disclosure of which is incorporated herein by reference in its entity.

### FIELD

Embodiments of the present disclosure generally relate to the field of live streaming, and in particular, to a method, an apparatus, a device, a medium, and a program product for processing a video stream.

### BACKGROUND

At present, in the field of live streaming, live streaming content has become increasingly rich, and types of the live streaming content have also become increasingly diverse. With the diversification of the live streaming content, cloud game live streaming has gradually stood out from various types of live streaming and has become a type of live streaming that is more popular among audiences nowadays, and the effect of the cloud game live streaming and the effect of interaction with the audiences have become better and better in the field of live streaming.

In a process of cloud game live streaming, it is usually necessary to merge a live streaming video stream of a live streaming end and a cloud game video stream of a server end, and then transmit the merged video stream to the audiences. Then, the audiences may pull the merged video stream via a content delivery network to watch. However, there are still problems that need to be improved and studied in terms of the merging of the video streams in the process of cloud game live streaming.

### SUMMARY

Embodiments of the present disclosure provide a method, an apparatus, a device, a medium, and a program product for processing a video stream.

A first aspect of the present disclosure provides a method for processing a video stream. The method includes sending, in response to a user starting a cloud game for live streaming at a live streaming end, a cloud game video stream for the cloud game to the live streaming end via a first transmission channel, the cloud game video stream including a cloud game video frame and an identifier of the cloud game video frame. The method further includes receiving a live streaming video stream for the live streaming end via a second transmission channel, a live streaming video frame in the live streaming video stream being associated with the identifier. The method further includes combining the cloud game video frame and the live streaming video frame based on the identifier to generate a combined video stream. The method further includes sending the combined video stream for live streaming of the cloud game.

A second aspect of the present disclosure provides a method for processing a video stream. The method includes receiving, in response to a user starting a cloud game for live streaming at a live streaming end, a cloud game video stream for the cloud game from a server end via a first transmission channel, the cloud game video stream including a cloud game video frame and an identifier of the cloud game video frame. The method further includes associating a live streaming video frame corresponding to the cloud game video frame in a live streaming video stream for the live streaming end with the identifier. The method further includes sending the live streaming video stream to the server end via a second transmission channel for live streaming of a combined video stream generated by the cloud game video frame and the live streaming video frame, the live streaming video stream including the live streaming video frame and the identifier associated with the live streaming video frame.

A third aspect of the present disclosure provides an apparatus for processing a video stream. The apparatus includes a video stream sending module configured to, in response to a user starting a cloud game for live streaming at a live streaming end, send a cloud game video stream for the cloud game to the live streaming end via a first transmission channel, the cloud game video stream including a cloud game video frame and an identifier of the cloud game video frame; a video stream receiving module configured to receive a live streaming video stream for the live streaming end via a second transmission channel, a live streaming video frame in the live streaming video stream being associated with the identifier; a video frame combining module configured to combine the cloud game video frame and the live streaming video frame based on the identifier to generate a combined video stream; and a video stream sending module configured to send the combined video stream for live streaming of the cloud game.

A fourth aspect of the present disclosure provides an apparatus for processing a video stream. The apparatus includes a video stream receiving module configured to, in response to a user starting a cloud game for live streaming at a live streaming end, receive a cloud game video stream for the cloud game from a server end via a first transmission channel, the cloud game video stream including a cloud game video frame and an identifier of the cloud game video frame; an association module configured to associate a live streaming video frame corresponding to the cloud game video frame in a live streaming video stream for the live streaming end with the identifier; and a video stream sending module configured to send the live streaming video stream to the server end via a second transmission channel for live streaming of a combined video stream generated by the cloud game video frame and the live streaming video frame, the live streaming video stream including the live streaming video frame and the identifier associated with the live streaming video frame.

A fifth aspect of the present disclosure provides an electronic device. The electronic device includes at least one processor; and a storage apparatus for storing at least one program which, when executed by the at least one processor, causes the at least one processor to implement the methods according to the first aspect and the second aspect of the present disclosure.

A sixth aspect of the present disclosure provides a computer-readable storage medium having a computer program stored thereon, the computer program, when executed by a processor, implementing the methods according to the first aspect and the second aspect of the present disclosure.

A seventh aspect of the present disclosure provides a computer program product. The computer program product includes a computer program which, when executed by a processor, implements the methods according to the first aspect and the second aspect of the present disclosure.

It should be understood that the content described in this section is not intended to identify key or important features of the embodiments of the present disclosure, nor is it intended to limit the scope of the present disclosure. Other features of the present disclosure will become readily comprehensible through the following description.

### BRIEF DESCRIPTION OF THE DRAWINGS

The above and other objects, features and advantages of the present disclosure will become more apparent through a more detailed description of the exemplary embodiments of the present disclosure in conjunction with the drawings, in which, in the exemplary embodiments of the present disclosure, the same reference numbers generally represent the same components.

FIG. 1 illustrates a schematic diagram of an example environment in which the device and/or the method of some embodiments of the present disclosure may be implemented;

FIG. 2 illustrates a schematic diagram of an example method for processing a video stream according to some embodiments of the present disclosure;

FIG. 3 illustrates a schematic diagram of another example method for processing a video stream according to some embodiments of the present disclosure;

FIG. 4 illustrates a schematic diagram of an example process for processing a video stream according to some embodiments of the present disclosure;

FIG. 5 illustrates a schematic diagram of another example architecture for processing a video stream according to some embodiments of the present disclosure;

FIG. 6 illustrates a schematic block diagram of an apparatus for processing a video stream according to some embodiments of the present disclosure;

FIG. 7 illustrates a schematic block diagram of another apparatus for processing a video stream according to some embodiments of the present disclosure; and

FIG. 8 illustrates a schematic block diagram of an example device suitable for implementing multiple embodiments of the present disclosure.

In each of the drawings, the same or corresponding reference numbers represent the same or corresponding parts.

### DETAILED DESCRIPTION OF EMBODIMENTS

It may be understood that the data involved in the technical solution (including but not limited to the data itself, acquisition or use of the data) should comply with requirements of corresponding laws, regulations, and related provisions.

It may be understood that before the use of the technical solution disclosed in the embodiments of the present disclosure, the user shall be informed of the type, range of use, use scenarios, etc., of personal information involved in the present disclosure and the authorization of the user shall be obtained in an appropriate manner in accordance with relevant laws and regulations.

For example, when a user’s active request is received, prompt information is sent to the user to clearly prompt the user that the requested operation will require access to and use of the user’s personal information. In this way, the user may independently choose, based on the prompt information, whether to provide the personal information to software or hardware, such as an electronic device, an application, a server, or a storage medium, that performs the operations of the technical solution of the present disclosure.

As an optional but non-limiting implementation, in response to receiving the user’s active request, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure, and other methods that satisfy the relevant laws and regulations may also be applied in the implementations of the present disclosure.

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for exemplary purposes, and are not intended to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The terms “first”, “second”, etc. may refer to different or same objects. Other definitions, either explicit or implicit, may also be included below.

In current live streaming field, it is becoming increasingly important to improve the experience of watching live streaming for audiences. With the diversification of live streaming content, cloud game live streaming has gradually stood out from various types of live streaming and has become a type of live streaming that is more popular among audiences nowadays. In this case, the merging of a live streaming video stream and a cloud game video stream in a live streaming process becomes an important process, which greatly affects the live streaming viewing experience of the audiences. A traditional scheme for merging the live streaming video stream and the cloud game video stream mainly depends on the network performance and encoding performance of a live streaming end, and requires the device performance to meet certain requirements.

For the traditional merging of the live streaming video stream and the cloud game video stream, there are two schemes. The first scheme is to synthesize audio and video of the cloud game and audio and video of the live streaming end locally and push the synthesized audio and video to the audiences, which requires the uplink network bandwidth and encoding performance of the live streaming end. If the requirements are not met, the live streaming images seen by the audience end will be blurred and stuck. The second scheme is to push the audio and video of the cloud game and the audio and video of the live streaming end respectively to a merging service in the cloud. The audio and video of the cloud game are pushed to the merging service directly when collected in the cloud, and then pushed to the audiences after being merged by the merging service. Compared with the first scheme, the second scheme reduces the network uplink bandwidth pressure and encoding pressure of the live streaming end. However, because the audio and video of the cloud game and the audio and video of the live streaming end are pushed at different ends, the merging node cannot align the audio and video of the two streams, which will lead to the asynchronization between the images of the live streaming end and the images of the cloud game. At the same time, at the merging node in the cloud, there will be one more image quality loss caused by encoding and decoding than local merging, which will also bring additional costs. This leads to an increase in resource consumption and a decline in the experience of watching live streaming for the audiences.

At least in order to solve the above and other potential problems, an embodiment of the present disclosure proposes a method for processing a video stream. In this method, first, after a user starts a cloud game for live streaming at a live streaming end, a cloud game video stream for the cloud game may be sent to the live streaming end via a first transmission channel. The cloud game video stream includes a cloud game video frame and an identifier of the cloud game video frame. In addition, after the cloud game video stream is sent, a live streaming video stream for the live streaming end is received via a second transmission channel. A live streaming video frame in the live streaming video stream is associated with the identifier. Next, after the live streaming video stream is received, the cloud game video frame and the live streaming video frame are combined at a server end according to the identifier to generate a combined video stream. Finally, the combined video stream is sent for live streaming of the cloud game. Through this method, the images of the cloud game and the live streaming are directly merged at the server end that generates the cloud game video stream, so as to avoid image quality loss caused by the encoding and decoding of the images of the cloud game, and by associating the cloud game video frame with the live streaming video frame, the cloud game video stream and the live streaming video stream are forced to be aligned during merging, thereby avoiding the problem of image asynchronization and improving the user experience of watching live streaming.

It may be understood that the present disclosure is only illustrated in conjunction with the relevant embodiments, and the protection scope of the present disclosure is not limited by the relevant embodiments. Any technical solution in other disclosures that falls within the protection scope of the present disclosure shall be protected.

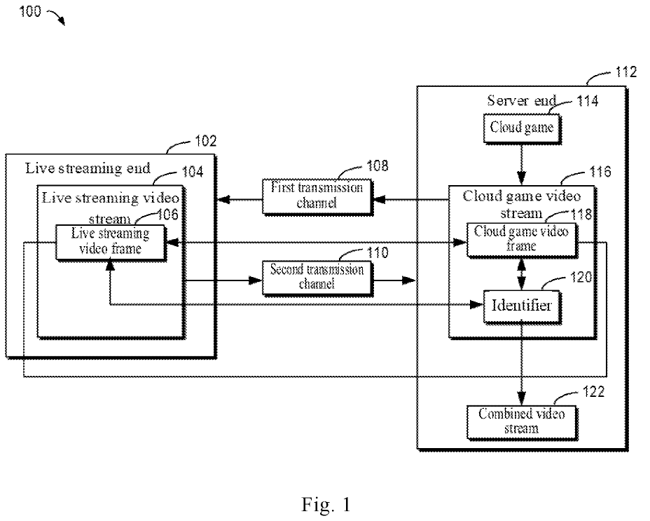

The embodiments of the present disclosure will be further described in detail below in conjunction with the drawings. FIG. 1 shows an example environment in which the device and/or the method of the embodiments of the present disclosure may be implemented. In an environment 100, a live streaming end 102 and a server end 112 are configured to generate a combined video stream 122, and any suitable computing device may be used as the live streaming end 102 and the server end 112 in the example environment. For example, the live streaming end 102 may be a smart device, such as a smart phone, and the server end 112 may be a cloud server, which may be used to run a cloud application, for example, may be used to run a cloud game. Data transmission is carried out between the live streaming end 102 and the server end 112 via a transmission channel. A first transmission channel 108 and a second transmission channel 110 may use the same transmission protocol for data transmission, or may use different data transmission protocols for data transmission, which is not limited in the present application. A cloud game 114 runs on the server end 112, and a user may use a software development kit (SDK) related to the cloud game at the live streaming end 102 to start and play the cloud game 114 at the live streaming end 102.

Examples of the live streaming end 102 include but are not limited to a mobile phone (e.g., a smart phone), a laptop computer, a personal digital assistant (PDA), an electronic book (e-book) reader, a portable game console, a portable media player, a game console, a set-top box (STB), a smart television (TV), a personal computer, a laptop computer, an in-vehicle computer (e.g., a navigation unit), etc. Examples of the server end 112 include but are not limited to a personal computer, a server computer, a handheld or laptop device, a mobile device, a multi-processor system, a consumer electronic product, a small computer, a mainframe computer, a distributed computing environment including any of the above systems or devices, etc.

As shown in FIG. 1, when the user wants to live stream a cloud game, he/she may start the cloud game 114 the via live streaming end 102 to live stream. The request for starting the cloud game will be sent to the server end 112 via the live streaming end 102. After receiving the user’s request, the server end 112 may start the cloud game 114. Then, the server end 112 starts to generate a cloud game video stream 116 for the cloud game 114. When generating a cloud game video frame 118 in the cloud game video stream 116, the server end 112 also determines an identifier 120 corresponding to the cloud game video frame 118. In an example, the identifier 120 may be used to indicate a generation time of the cloud game video frame 118, for example, the identifier 120 may be used to indicate at which specific time the cloud game video frame 118 is generated, and time information in the identifier 120 may be presented in the form of a time stamp. In another example, the identifier 120 may be any suitable identifier that may identify the cloud game video frame.

Next, the server end 112 may send the cloud game video stream 116 associated with the cloud game 114 to the live streaming end 102 via the first transmission channel 108. The cloud game video stream 116 includes the cloud game video frame 118 and the identifier 120 of the cloud game video frame 118. Additionally, the server end 112 also acquires a cloud game audio stream corresponding to the cloud game video stream, and sends the cloud game audio stream synchronously when sending the cloud game video stream.

After receiving the cloud game video stream 116, the live streaming end 102 synchronously acquires a user live streaming of the user for the cloud game, for example, acquires a live streaming video stream 104 for the user. Then, the client 102 associates a corresponding live streaming video frame in the live streaming video stream 104 with the identifier 120 corresponding to the cloud game video frame 118 included in the cloud game video stream 116. For example, the identifier 120 corresponding to the cloud game video frame 118 and the live streaming video frame 106 are stored in association, for example, the identifier is stored in metadata of the live streaming video frame 106, so as to associate the live streaming video frame 106 with the identifier 120, thereby facilitating the subsequent association between the live streaming video frame 106 and the cloud game video frame 118. Then, the live streaming end 102 sends the live streaming video stream 104 to the server end 112 via the second transmission channel 110.

After receiving the live streaming video stream 104, the server end 112 further uses the identifier 120 associated with the live streaming video frame 106 to combine the live streaming video frame 106 and the cloud game video frame 116, thereby obtaining a combined video stream 122. It should be noted that the acquisition and generation of the cloud game video stream 116 and the generation of the combined video stream 122 are all executed at the server end 112.

Finally, after generating the combined video stream 122, the server end 112 sends the combined video stream 122 for live streaming of the cloud game 114. For example, the server end 112 sends the combined video stream 122 to a content delivery network (CDN), and then sends the combined video stream 122 to an audience via the CDN to live stream the cloud game 114. Additionally, a cloud game audio frame and the cloud game video frame are transmitted to the live streaming end 102 via the first transmission channel 108 using a first transmission protocol, and a live streaming audio stream and the live streaming video stream for the live streaming end are transmitted to the server end 112 via the second transmission channel 110 using a second transmission protocol.

Through this method, the images of the cloud game and the live streaming are directly merged at the server end that generates the cloud game video stream, so as to avoid the image quality loss caused by the encoding and decoding of the images of the cloud game, and by associating the cloud game video frame with the live streaming video frame, the cloud game video stream and the live streaming video stream are forced to be aligned during merging, thereby avoiding the problem of image asynchronization and improving the user experience of watching live streaming.

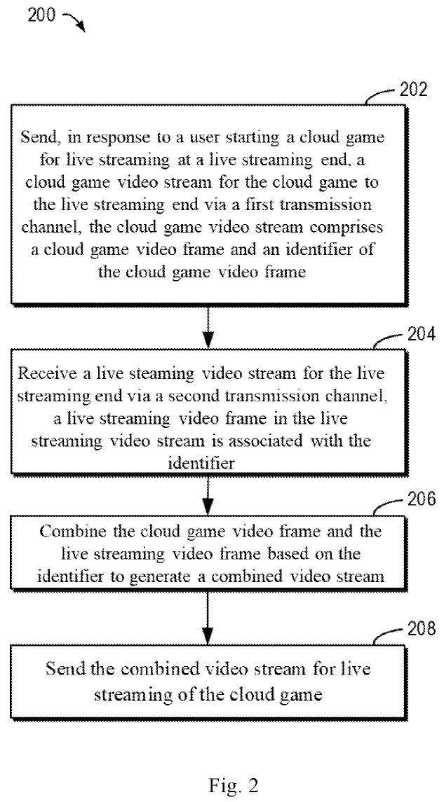

The schematic diagram of the example environment in which the device and/or the method of some embodiments of the present disclosure may be implemented is described above in conjunction with FIG. 1, and the schematic diagram of an example method 200 for processing a video stream according to some embodiments of the present disclosure is described below in conjunction with FIG. 2. The example method 200 may be executed by the server end 102 in FIG. 1 or any other suitable computing device.

As shown in FIG. 2, in the example method 200, at block 202, in response to a user starting a cloud game for live streaming at a live streaming end, a cloud game video stream for the cloud game is sent to the live streaming end via a first transmission channel, the cloud game video stream including a cloud game video frame and an identifier of the cloud game video frame.

In some embodiments, after the cloud game 114 is started, the server end 112 also first acquires the cloud game video stream 116 for the cloud game 114, determines the identifier 120 corresponding to the cloud game video frame 118 in the cloud game video stream 116 in the process of acquiring the cloud game video stream 116, and then sends the cloud game video stream 116 including the cloud game video frame 118 and the identifier 120 to the live streaming end 102 via the first transmission channel 108. The process of acquiring the cloud game video frame 118 is executed at the server end 112.

Additionally, when acquiring the cloud game video stream 116 of the cloud game 114, the server end 112 also acquires a cloud game audio stream of the cloud game 114, and the acquired cloud game audio stream is associated with the cloud game video stream 116. After acquiring the cloud game audio stream of the cloud game, the cloud game audio stream is further sent to the live streaming end 102 via the first transmission channel 108. It should be noted that in the process of sending the cloud game video stream 116 and the cloud game audio stream to the live streaming end 102 via the first transmission channel 108, the cloud game video stream 116 and the cloud game audio stream may also be aligned using a first transmission protocol for the first transmission channel 108. The first transmission protocol may be a real time communication (RTC) transmission protocol, or may be any other transmission protocol that may align the cloud game video stream 116 and the cloud game audio stream, which is not limited in the present application.

Then, at block 204, a live streaming video stream for the live streaming end is received via a second transmission channel, a live streaming video frame in the live streaming video stream is associated with the identifier.

In some embodiments, in the process of receiving the live streaming video stream 104 from the live streaming end 102 via the second transmission channel 110, the server end 112 acquires metadata of the live streaming video frame for the live streaming video stream 104. In an example, the metadata of the live streaming video frame 106 further includes the identifier 120 corresponding to the cloud game video frame 118. In another example, the metadata of the live streaming video frame 106 also includes other information of the live streaming video frame 106, such as pixel information, color information, etc. After acquiring the metadata of the live streaming video frame 106, the server end 112 also determines the identifier 120 corresponding to the live streaming video frame 106 in the metadata.

In some embodiments, after receiving the live streaming video stream 104 from the live streaming end 102, the server end 112 also decodes the received live streaming video stream. By decoding the live streaming video stream 104, the compressed live streaming video frame 106 may be decompressed, thereby acquiring a live streaming image with a higher bit rate.

Additionally, in the process of receiving the live streaming video stream 104, the server end 112 also uses the second transmission channel 110 to receive a live streaming audio stream of the live streaming end 102, and the received live streaming audio stream is associated with the live streaming video stream 104. It should be noted that in the process of receiving the live streaming video stream 104 and the live streaming audio stream via the second transmission channel 110, the live streaming video stream 104 and the live streaming audio stream may also be aligned using a second transmission protocol for the second transmission channel 110. In an example, the second transmission protocol may be the same transmission protocol as the first transmission protocol. In another example, the second transmission protocol may also be a different transmission protocol from the first transmission protocol. The present application does not limit this herein.

Next, at block 206, the cloud game video frame and the live streaming video frame are combined based on the identifier to generate a combined video stream. It should be noted that the process of combining the cloud game video frame 118 and the live streaming video frame 106 is executed at the server end 112.

In some embodiments, after acquiring the live streaming video frame 106 at the server end 112, the acquired live streaming video frame 106 and the acquired cloud game video frame 118 may be further aligned according to the identifier 120. Aligning the live streaming video frame 106 with the cloud game video frame 118 may synchronize the images of the live streaming and the cloud game, and may reduce the problem of image asynchronization when the cloud game 114 is live streamed. Subsequently, the aligned cloud game video frame 118 and the aligned live streaming video frame 106 are combined to obtain the combined video stream 122.

In some embodiments, for the convenience of description, the cloud game video frame 118 in the cloud game video stream 116 sent by the server end 112 to the live streaming end 102 is called a first cloud game video frame, and the identifier may be a time stamp, which represents a specific moment when the cloud game video frame is generated. In the process of aligning the cloud game video frame with the live streaming video frame, it is also necessary to acquire a second cloud game video frame generated when the live streaming video frame 106 is received, and acquire a reference time stamp for the second cloud game video frame. It may be understood that the specific moment corresponding to the reference time stamp should be later than the specific moment corresponding to the time stamp, that is, the second cloud game video frame is a cloud game video frame that is newer in time than the first cloud game video frame.

After acquiring the reference time stamp, a time delay between the reference time stamp and the time stamp may be further determined. In an example, the specific moment corresponding to the reference time stamp is 0.5 seconds greater than the specific moment corresponding to the time stamp. In this case, the time delay between the reference time stamp and the time stamp is 0.5 seconds. Therefore, the cloud game video frame may be delayed by the time delay, for example, 0.5 seconds, to align with the received live streaming video frame. For example, the cloud game video frame and a corresponding identifier in the cloud game video stream may be cached at the server end, and then the cloud game video frame corresponding to the received identifier may be searched for from the cached cloud game video using the received identifier. In this way, the first cloud game video frame acquired at the server end 112 may be actively delayed, and the first cloud game video frame is aligned with the live streaming video frame and merged, so that the images of live streaming and the cloud game are synchronized.

Finally, at block 208, the combined video stream is sent for live streaming of the cloud game. After obtaining the combined video stream, the server end 112 may use the combined video stream to live stream.

In some embodiments, after determining the combined video stream 122, the server end 112 sends the determined combined video stream 122 to the CDN, and then the CDN may send the combined video stream 122 to an audience end for live streaming of the cloud game 114.

Additionally, the server end 112 also mixes the live steaming audio stream received and the cloud game audio stream corresponding to the cloud game video stream 116 from the live streaming end 102 to obtain a mixed audio stream after mixing, and finally sends the mixed audio stream to the CDN, and sends the mixed audio stream to the audience end via the CDN to live stream the cloud game 114.

Through this method, the images of the cloud game and the live streaming are directly merged at the server end, so as to avoid the image quality loss caused by the encoding and decoding, and by associating the cloud game video frame with the live streaming video frame, the cloud game video stream and the live streaming video stream are forced to be aligned during merging, thereby avoiding the problem of image asynchronization and improving the experience of watching live streaming for the user.

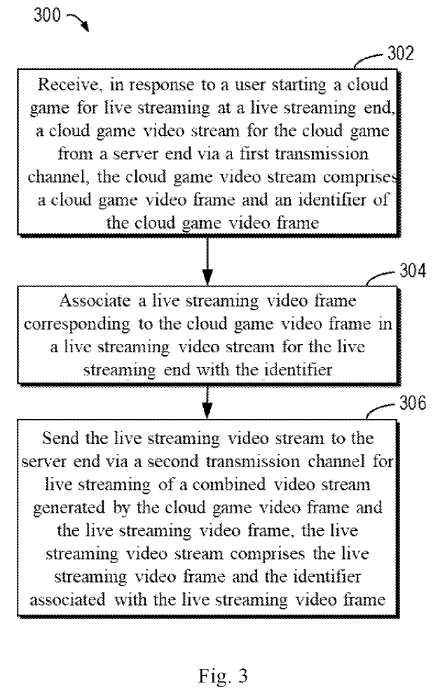

The schematic diagram of the example method 200 for processing a video stream according to some embodiments of the present disclosure is described above in conjunction with FIG. 2. The schematic diagram of another example method 300 for processing a video stream according to some embodiments of the present disclosure is described below in conjunction with FIG. 3. The example method 300 may be executed by the live streaming end 102 in FIG. 1 or any other suitable computing device.

As shown in FIG. 3, in the example method 300, at block 302, in response to a user starting a cloud game for live streaming at a live streaming end, a cloud game video stream for the cloud game is received from a server end via a first transmission channel, the cloud game video stream including a cloud game video frame and an identifier of the cloud game video frame.

In some embodiments, after the user starts the cloud game 114 and after the live streaming end 102 receives the cloud game video stream 116 from the server end 112, the cloud game video frame 118 included in the cloud game video stream 116 and the identifier 120 corresponding to the cloud game video frame 118 are further determined.

Then, at block 304, a live streaming video frame corresponding to the cloud game video frame in a live streaming video stream for the live streaming end is associated with the identifier.

In some embodiments, after the user starts the cloud game 114 and after the live streaming end 102 receives the cloud game video stream 116 from the server end 112, the identifier 120 included in the cloud game video stream 116 may be written into the metadata of the live streaming video frame 106 of the live streaming video stream 104. In this way, the live streaming video frame 106 may be associated with the identifier 120.

Finally, at block 306, the live streaming video stream is sent to the server end via the second transmission channel for live streaming of a combined video stream generated by the cloud game video frame and the live streaming video frame, the live streaming video stream includes the live streaming video frame and the identifier associated with the live streaming video frame.

In some embodiments, before sending the live streaming video stream 104 to the server end 112 at the live streaming end 102, the live streaming video stream 104 is also encoded, and the encoded live streaming video stream 104 is sent to the server end 112 via the second transmission channel 110. Compressing the live streaming video stream 104 may improve the data transmission efficiency of the live streaming video stream 104 in the second transmission channel 110.

Additionally, when sending the live streaming video stream 104 to the server end 112 at the live streaming end 102, the live streaming end 102 also acquires the live streaming audio stream corresponding to the live streaming video stream 104, and sends the live streaming audio stream corresponding to the live streaming video stream 104 to the server end 112 via the second transmission channel 110.

Through this method, the images of the cloud game and the live streaming are directly merged at the server end, so as to avoid the image quality loss caused by the encoding and decoding, and by associating the cloud game video frame with the live streaming video frame, the cloud game video stream and the live streaming video stream are forced to be aligned during merging, thereby avoiding the problem of image asynchronization and improving the user experience of watching live streaming.

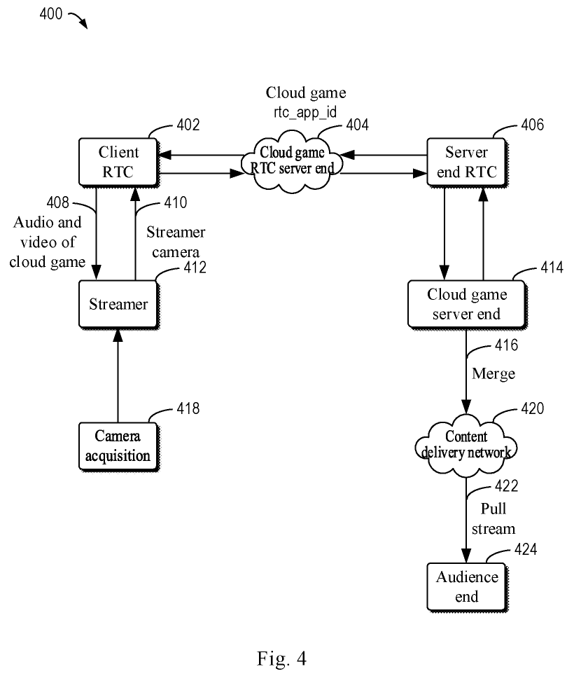

The schematic diagram of the example method 300 for processing a video stream according to some embodiments of the present disclosure is described above in conjunction with FIG. 3. The schematic diagram of an example process for processing a video stream according to some embodiments of the present disclosure is described below in conjunction with FIG. 4.

As shown in FIG. 4, in an example 400, a related description is given by live streaming of a cloud game by a streamer 412 as an example. First, when the streamer 412 starts the cloud game for live streaming, subsequently, at 414, a cloud game video stream of the cloud game is acquired at a cloud game server end, where the cloud game server end may be a group of containers at the server end for running a cloud game instance. Next, after acquiring the cloud game video stream, at 406, the acquired cloud game video stream is transmitted to a cloud game real-time communication (RTC) server end located at 404 via the server end RTC, and the cloud game may be represented by rtc_app_id. Additionally, in the process of acquiring the cloud game video stream, an audio stream of the cloud game is also acquired and an identifier of the cloud game video for the cloud game video stream is determined, and when the cloud game video stream is transmitted to the cloud game RTC server end, the cloud game audio stream and the identifier are also transmitted together. In an example, the identifier is a time stamp.

Then, at 402, a cloud game video frame is transmitted to a live streaming client via a client RTC, and the live streaming client may be used to start a live streaming room and live stream the corresponding cloud game, and the live streaming client may also be used to provide an audio and video streaming service for the live streaming end, providing the audio and video streaming capability of the live streaming client. After receiving audio and video of the cloud game, the live streaming client transmits the audio and video of the cloud game to the streamer 412 at 408.

In the process of the streamer 412 receiving the audio and video of the cloud game for the cloud game, at 418, a camera of the streamer 412 is also acquired, so as to obtain a live streaming video frame for the streamer 412 and acquire a live streaming video stream for the streamer 412. Next, at 410, the streamer 412 transmits the acquired streamer camera information, that is, the live streaming video stream, to the live streaming client, and the live streaming client transmits the live streaming video stream to the cloud game RTC server end located at 404 using a real-time communication protocol with the cloud game server end. Additionally, the live streaming client also associates the time stamp in the received cloud game video stream with the live streaming video frame in the live streaming video stream, to align the live streaming video frame with the cloud game video frame. And subsequently, the live streaming audio, video and time stamp are further transmitted to the cloud game RTC server end located at 404.

Then, after the cloud game RTC server end receiving the live streaming video stream and the time stamp from the live streaming end, the live streaming video stream and the time stamp is transmitted to the cloud game server end located at 414 via the server end RTC at 406. Additionally, at 414, the cloud game server end also acquires a cloud game video frame at the latest moment and actively delays the cloud game video frame according to a time delay between the time stamp and a reference time stamp of the latest cloud game video frame to align the cloud game video frame with the received live streaming video frame. Subsequently, at 416, the aligned live streaming video frame and the cloud game video frame at the latest moment are merged and sent to a content delivery network 420. Finally, an audience end 424 where an audience is located pulls a stream at 422 to obtain the merged images of the live streaming and the cloud game to watch the cloud game live streaming. Additionally, the live streaming audio stream and the cloud game audio stream are also aligned and mixed, and the audience at the audience end 424 may also pull the mixed audio stream at 422 to watch the cloud game live streaming.

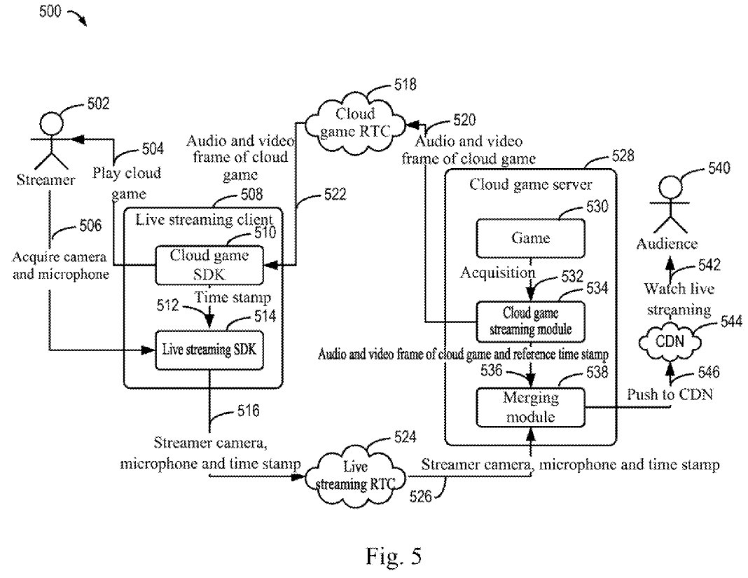

The schematic diagram of the example process for processing a video stream according to some embodiments of the present disclosure is described above in conjunction with FIG. 4. The schematic diagram of another example architecture for processing a video stream according to some embodiments of the present disclosure is described below in conjunction with FIG. 5.

As shown in FIG. 5, in an example 500, in combination with the previous example 400, an example architecture includes a live streaming client 508 and a cloud game server 528. The live streaming client 508 may be used as the live streaming end 102 in FIG. 1, and the cloud game server may be used as the server end 112 in FIG. 1. The live streaming client 508 provides the capability of starting a live streaming room. A streamer 502 uses the live streaming client 508 to start a live streaming room for live streaming and selects a cloud game to be live streamed, and an audience may watch live streaming content in the live streaming room at an audience end. A cloud game SDK 510 and a live streaming SDK 512 are integrated in the live streaming client 508, where the cloud game SDK 510 provides the capability of playing a cloud game, the streamer 502 may start the cloud game in the live streaming client 508 via the cloud game SDK 510, the live streaming SDK 512 provides the capability of starting a live streaming room, and may also acquire data of a camera and a microphone of the streamer 502, and the live streaming SDK 512 may also push the acquired audio and video data to a live streaming RTC 524 to complete subsequent merging. The cloud game server 528 provides an operating environment for running a game 530, and also provides the capabilities of game streaming and merging. A cloud game streaming module 534 and a merging module 538 are integrated in the cloud game server 528. The cloud game streaming module 534 may acquire and push audio and video of the cloud game to the live streaming client 508, the streamer may play the cloud game using the live streaming client, and at the same time, the cloud game streaming module 534 also transmits the acquired audio and video of the cloud game to the merging module 538. The merging module 538 is configured to receive the audio and video of the cloud game from the cloud game streaming module 534 and audio and video of live streaming from the live streaming client 508, and calculate a time delay between the audio and video of the live streaming and the audio and video of the cloud game, to complete the alignment between the audio and video of the live streaming and the audio and video of the cloud game, and merge the aligned audio and video.

First, the streamer 502 is at the live streaming client 508 and starts the game 530 running at the cloud game server 528 at 504, where the game 530 is a cloud game. Subsequently, the cloud game streaming module 534 acquires audio and video of the cloud game for the game 530 at 532 and determines a time stamp for the audio and video of the cloud game, and then the cloud game server 528 transmits the audio and video of the cloud game and the time stamp to a cloud game RTC 518 at 520, and transmits the audio and video of the cloud game and the time stamp to the live streaming client 508 at 522 via the cloud game RTC 518. In the process of the live streaming client 508 receiving the audio and video of the cloud game and the time stamp, the live streaming SDK 514 also acquires the camera and the microphone for the streamer 502 at 506, that is, acquires the audio and video of the live streaming. Next, the live streaming SDK 514 also acquires the time stamp at 512 and writes the time stamp into the metadata of the live streaming video frame.

Next, at 516, the live streaming SDK 514 transmits the streamer camera, microphone and time stamp to the live streaming RTC 524, that is, transmits the audio and video of the live streaming for the live streaming client 508 and the time stamp to the live streaming RTC 524. Then, at 526, the live streaming RTC 524 transmits the streamer camera, microphone and time stamp to the merging module 538 in the cloud game server 528, that is, transmits the audio and video of the live streaming for the live streaming client 508 and the time stamp to the merging module 538. When receiving the audio and video of the live streaming and the time stamp, the merging module 538 also acquires a cloud game video frame at the latest moment from the cloud game streaming module 534 at 536 and determines a reference time stamp for the cloud game video frame at the latest moment, and determines a time delay of the cloud game video frame according to the time stamp and the reference time stamp at the merging module 538, and then actively delays the cloud game video frame by the time delay to align the cloud game video frame with the live streaming video frame. In an example, if the time delay between the reference time stamp and the time stamp is 1 second, the cloud game video frame is actively delayed by 1 second at the merging module 538 to align the live streaming video frame with the cloud game video frame. After the live streaming video frame is aligned with the cloud game video frame, the live streaming video frame and the video frame are combined to obtain a combined video stream, and subsequently, at 546, the combined video stream is pushed to a CDN 544.

Finally, at 542, an audience 540 pulls the combined video stream from the CDN 544 to watch the live streaming. Additionally, the merging module 538 also aligns and mixes the live streaming audio frame with the cloud game audio frame to obtain a mixed audio frame and sends the mixed audio frame to the CDN 544 at 546, and the audience may also pull the mixed audio stream at 542 while pulling the combined video stream, for watching the cloud game live streaming.

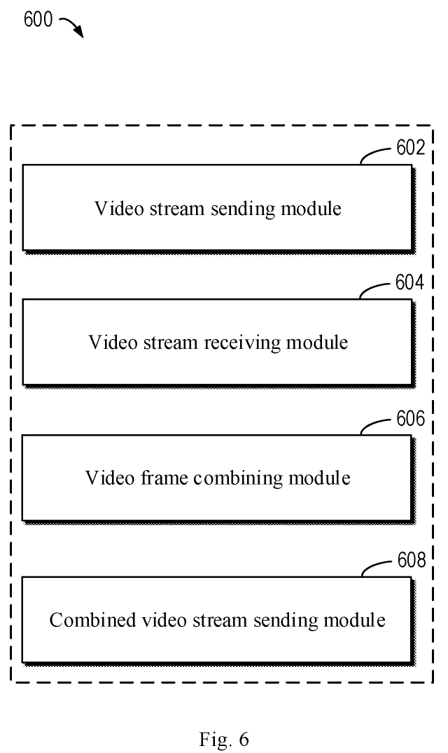

As shown in FIG. 6, an apparatus 600 includes a video stream sending module 602 configured to, in response to a user starting a cloud game for live streaming at a live streaming end, send a cloud game video stream for the cloud game to the live streaming end via a first transmission channel, the cloud game video stream including a cloud game video frame and an identifier of the cloud game video frame; a video stream receiving module 604 configured to receive a live streaming video stream for the live streaming end via a second transmission channel, a live streaming video frame in the live streaming video stream being associated with the identifier; a video frame combining module 606 configured to combine the cloud game video frame and the live streaming video frame based on the identifier to generate a combined video stream; and a combined video stream sending module 608 configured to send the combined video stream for live streaming of the cloud game.

In some embodiments, the video stream receiving module 604 includes: a metadata acquiring module configured to acquire metadata for the live streaming video frame in the live streaming video stream; and an identifier determining module configured to determine, from the metadata, the identifier of the cloud game video frame corresponding to the live streaming video frame.

In some embodiments, the video stream receiving module 604 further includes: a decoding module configured to, in response to receiving the live streaming video stream, generate a decoded live streaming video stream by decoding the live streaming video stream.

In some embodiments, the video frame combining module 606 includes: an alignment module configured to align the cloud game video frame with the live streaming video frame based on the identifier; and a combination module configured to combine the cloud game video frame and the live streaming video frame to generate the combined video stream.

In some embodiments, the cloud game video frame is a first cloud game video frame, the identifier is a time stamp, and the alignment module includes: a reference time stamp acquiring module configured to acquire a reference time stamp of a second cloud game video frame generated when the live streaming video frame is received; a time delay determining module configured to determine a time delay for the cloud game video frame based on the time stamp and the reference time stamp; and a delay module configured to align the first cloud game video frame with the live streaming video frame by delaying the first cloud game video frame by the time delay.

In some embodiments, the combined video stream sending module 608 includes: an acquisition module configured to acquire a cloud game video frame for the cloud game; an identifier determining module configured to determine the identifier of the cloud game video frame; and a sending module configured to send the cloud game video stream including the cloud game video frame and the identifier to the live streaming end via the first transmission channel.

In some embodiments, the apparatus 600 further includes: an audio stream acquisition module configured to acquire a cloud game audio stream for the cloud game; and an audio stream sending module configured to send the cloud game audio stream to the live streaming end via the first transmission channel in association with the cloud game video stream.

In some embodiments, the apparatus 600 further includes: an audio stream receiving module configured to receive a live streaming audio stream for the live streaming end via the second transmission channel, where the live audio stream is associated with the live streaming video stream; a mixing module configured to generate a mixed audio stream by mixing the cloud game audio stream and the live streaming audio stream; and an audio stream sending module configured to send the mixed audio stream in association with the combined video stream.

In some embodiments, the cloud game video stream and the cloud game audio stream are aligned using a first transmission protocol for the first transmission channel, and the live streaming video stream and the live streaming audio stream are aligned using a second transmission protocol for the second transmission channel.

In some embodiments, the generation of the cloud game video stream and the generation of the combined video stream are both executed at a server end running the cloud game.

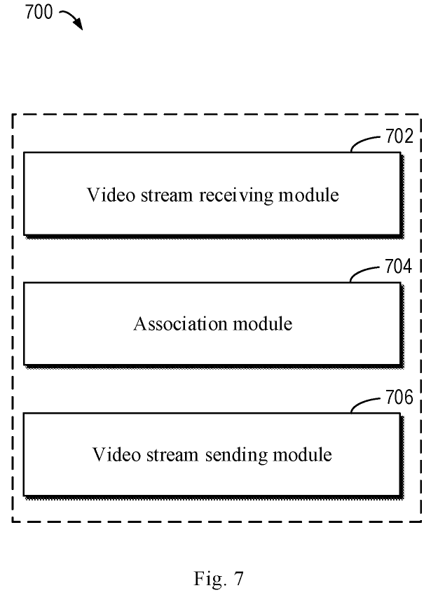

As shown in FIG. 7, an apparatus 700 includes a video stream receiving module 702 configured to, in response to a user starting a cloud game for live streaming at a live streaming end, receive a cloud game video stream for the cloud game from a server end via a first transmission channel, where the cloud game video stream includes a cloud game video frame and an identifier of the cloud game video frame; an association module 704 configured to associate a live streaming video frame corresponding to the cloud game video frame in a live streaming video stream for the live streaming end with the identifier; and a video stream sending module 706 configured to send the live streaming video stream to the server end via a second transmission channel for live streaming of a combined video stream generated by the cloud game video frame and the live streaming video frame, where the live streaming video stream includes the live streaming video frame and the identifier associated with the live streaming video frame.

In some embodiments, the association module 704 includes: a writing module configured to write the identifier into metadata of the live streaming video frame in the live streaming video stream.

In some embodiments, the video stream sending module 706 further includes: an encoding module configured to generate an encoded live streaming video stream by encoding the live streaming video stream; and a video stream sending module configured to send the encoded live streaming video stream to the server end via the second transmission channel.

In some embodiments, the apparatus 700 further includes: an audio stream acquisition module configured to acquire a live streaming audio stream associated with the live streaming video stream; and an audio stream sending module configured to send the live streaming audio stream for the live streaming end via the second transmission channel.

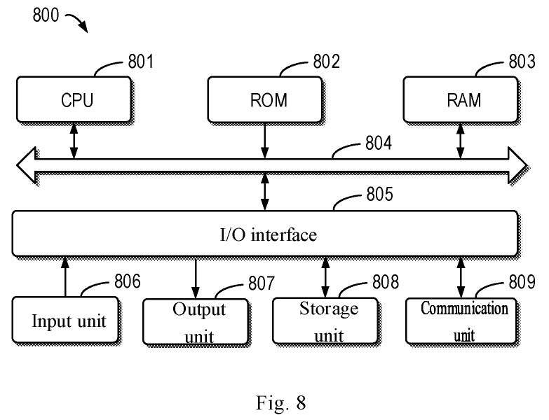

FIG. 8 shows a schematic block diagram of an example device 800 that may be used to implement the embodiments of the present disclosure. The computing device corresponding to the live streaming end 102 or the server end 102 in FIG. 1 may be implemented using the device 800. As shown in the figure, the device 800 includes a central processing unit (CPU) 801, which may perform various appropriate actions and processes according to computer program instructions stored in a read-only memory (ROM) 802 or computer program instructions loaded from a storage unit 808 into a random access memory (RAM) 803. In the RAM 803, various programs and data required for the operation of the device 800 may also be stored. The CPU 801, the ROM 802 and the RAM 803 are connected to each other via a bus 804. An input/output (I/O) interface 805 is also connected to the bus 804.

Multiple components in the device 800 are connected to the I/O interface 805, and the components include: an input unit 806, such as a keyboard, a mouse, etc.; an output unit 807, such as various types of displays, speakers, etc.; the storage unit 808, such as a magnetic disk, an optical disc, etc.; and a communication unit 809, such as a network card, a modem, a wireless communication transceiver, etc. The communication unit 809 allows the device 800 to exchange information/data with other devices via a computer network such as Internet and/or various telecommunication networks.

The various processes and processing described above, such as the methods 200 and 300, and the examples 400 to 500, may be executed by the processing unit 801. For example, in some embodiments, the methods 200 and 300, and the examples 400 to 500 may be implemented as computer software programs, which are tangibly contained in a machine-readable medium, such as the storage unit 808. In some embodiments, a portion or an entirety of the computer program may be loaded and/or installed into the device 800 via the ROM 802 and/or the communication unit 809. When the computer program is loaded into the RAM 803 and executed by the CPU 801, one or more actions of the example methods 200, 300, and the examples 400 to 500 described above may be executed.

The present disclosure may be a method, an apparatus, a system, and/or a computer program product. The computer program product may include a computer-readable storage medium having computer-readable program instructions thereon for performing various aspects of the present disclosure.

The computer-readable storage medium may be a tangible device that may hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, such as a punched card or an a raised structure in a groove with instructions stored thereon, and any suitable combination thereof. The computer-readable storage medium used herein is not interpreted as an instantaneous signal itself, such as a radio wave or other freely propagating electromagnetic waves, electromagnetic waves propagating through a waveguide or other transmission media (for example, light pulses through an optical fiber cable), or electrical signals transmitted through wires.

The computer-readable program instructions described herein may be downloaded from the computer-readable storage medium to various computing/processing devices, or downloaded to an external computer or an external storage device via a network, such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network, and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, the programming languages including object-oriented programming languages such as Smalltalk, C++, and conventional procedural programming languages such as "C" language or similar programming languages. The computer-readable program instructions may be executed entirely on a user's computer, partly on the user's computer, as a stand-alone software package, partly on the user's computer and partly on a remote computer, or entirely on the remote computer or a server. In the case of involving the remote computer, the remote computer may be connected to the user's computer through any kind of network, including a local area network (LAN) or a wide area network (WAN), or it may be connected to an external computer (for example, connected via Internet with the aid of an Internet service provider). In some embodiments, by customizing an electronic circuit, such as a programmable logic circuit, a field programmable gate array (FPGA), or a programmable logic array (PLA), with state information of the computer-readable program instructions, the electronic circuit may execute the computer-readable program instructions, thereby implementing various aspects of the present disclosure.

Various aspects of the present disclosure are described herein with reference to flowcharts and/or block diagrams of methods, apparatus (systems), and computer program products according to embodiments of the present disclosure. It should be understood that each block of the flowcharts and/or block diagrams, and combinations of blocks in the flowcharts and/or block diagrams, may be implemented by the computer-readable program instructions.

These computer-readable program instructions may be provided to a processing unit of a general-purpose computer, a special-purpose computer, or other programmable data processing apparatus to produce a machine, such that when the instructions are executed by the processing unit of the computer or other programmable data processing apparatus, an apparatus for implementing a function/action specified in one or more blocks in the flowcharts and/or block diagrams is produced. These computer-readable program instructions may also be stored in the computer-readable storage medium, these instructions cause the computer, the programmable data processing apparatus, and/or other devices to work in a specific manner, and thus, the computer-readable medium storing the instructions includes a manufactured product, which includes instructions for implementing various aspects of the function/action specified in one or more blocks of the flowcharts and/or block diagrams.

The computer-readable program instructions may also be loaded onto a computer, other programmable data processing apparatus, or other devices, such that a series of operations and steps are performed on the computer, other programmable data processing apparatus, or other devices, so as to produce a computer-implemented process, which causes the instructions executed on the computer, other programmable data processing apparatus, or other devices to implement the function/action specified in one or more blocks of the flowcharts and/or block diagrams.

The flowcharts and block diagrams in the drawings illustrate the possibly implemented architectures, functions, and operations of the systems, methods and computer program products according to multiple embodiments of the present disclosure. In this regard, each block in the flowchart or block diagrams may represent a module, program segment, or a portion of instructions, which contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block of the block diagrams and/or flowcharts, and combinations of the blocks in the block diagrams and/or flowcharts may be implemented by a dedicated hardware-based system that perform specified functions or actions, or may be implemented by a combination of special-purpose hardware and computer instructions.

The embodiments of the present disclosure have been described above, and the above description is exemplary, non-exhaustive, and not limited to the disclosed embodiments. Many modifications and variations will be apparent to those of ordinary skill in the art without departing from the scope and spirit of the described embodiments. The terms used herein are chosen to best explain the principles of the embodiments, the practical applications or the improvements to the technologies in the market, or to enable other ordinary skill in the art to understand the embodiments disclosed herein.

We claim:

1. A method for processing a video stream, comprising:
sending, in response to a user starting a cloud game for live streaming at a live streaming end, a cloud game video stream for the cloud game to the live streaming end via a first transmission channel, the cloud game video stream comprising a cloud game video frame and an identifier of the cloud game video frame;
receiving a live steaming video stream for the live streaming end via a second transmission channel, a live streaming video frame in the live streaming video stream being associated with the identifier;
combining the cloud game video frame and the live streaming video frame based on the identifier to generate a combined video stream; and
sending the combined video stream for live streaming of the cloud game.

2. The method of claim 1, wherein receiving the live streaming video stream for the live streaming end via the second transmission channel comprises:
obtaining metadata for the live streaming video frame in the live streaming video stream; and
determining, from the metadata, the identifier of the cloud game video frame corresponding to the live streaming video frame.

3. The method of claim 2, wherein receiving the live streaming video stream for the live streaming end via the second transmission channel further comprises:
generating, in response to the live streaming video stream being received, a decoded live streaming video stream by decoding the live streaming video stream.

4. The method of claim 1, wherein combining the cloud game video frame and the live streaming video frame based on the identifier to generate the combined video stream comprises:
aligning the cloud game video frame with the live streaming video frame based on the identifier; and
combining the cloud game video frame and the live streaming video frame to generate the combined video stream.

5. The method of claim 4, wherein the cloud game video frame is a first cloud game video frame, the identifier is a timestamp, and aligning the cloud game video frame with the live streaming video frame comprises:
obtaining a reference timestamp of a second cloud game video frame generated upon the live streaming video frame being received;
determining a time delay for the cloud game video frame based on the timestamp and the reference timestamp; and
aligning the first cloud game video frame with the live streaming video frame by delaying the first cloud game video frame by the time delay.

6. The method of claim 1, wherein sending the cloud game video stream for the cloud game to the live streaming end via the first transmission channel comprises:
acquiring the cloud game video frame for the cloud game;
determining the identifier of the cloud game video frame; and
sending the cloud game video stream comprising the cloud game video frame and the identifier to the live streaming end via the first transmission channel.

7. The method of claim 6, further comprising:
acquiring a cloud game audio stream for the cloud game; and
sending the cloud game audio stream to the live streaming end via the first transmission channel in association with the cloud game video stream.

8. The method of claim 7, further comprising:
receiving a live streaming audio stream for the live streaming end via the second transmission channel, the live streaming audio stream being associated with the live streaming video stream;
generating a mixed audio stream by mixing the cloud game audio stream and the live streaming audio stream; and
sending the mixed audio stream in association with the combined video stream.

9. The method of claim 8, wherein the cloud game video stream and the cloud game audio stream are aligned using a first transmission protocol for the first transmission channel, and the live streaming video stream and the live streaming audio stream are aligned using a second transmission protocol for the second transmission channel.

10. The method of claim 1, wherein generation of the cloud game video stream and generation of the combined video stream are both performed at a server end running the cloud game.

11. A method for processing a video stream, comprising:
receiving, in response to a user starting a cloud game for live streaming at a live streaming end, a cloud game video stream for the cloud game from a server end via a first transmission channel, the cloud game video stream comprising a cloud game video frame and an identifier of the cloud game video frame;
associating a live streaming video frame corresponding to the cloud game video frame in a live streaming video stream for the live streaming end with the identifier; and
sending the live streaming video stream to the server end via a second transmission channel for live streaming of a combined video stream generated by the cloud game video frame and the live streaming video frame, the live streaming video stream comprising the live streaming video frame and the identifier associated with the live streaming video frame.

12. The method of claim 11, wherein associating the live streaming video frame corresponding to the cloud game video frame in the live streaming video stream for the live streaming end with the identifier comprises:
writing the identifier into metadata of the live streaming video frame into the live streaming video stream.

13. The method of claim 11, wherein sending the live streaming video stream to the server end via the second transmission channel for live streaming of the combined video stream generated by the cloud game video frame and the live streaming video frame further comprises:
generating an encoded live streaming video stream by encoding the live streaming video stream; and
sending the encoded live streaming video stream to the server end via the second transmission channel.

14. The method of claim 11, further comprising:
obtaining a live streaming audio stream associated with the live streaming video stream; and
sending the live streaming audio stream for the live streaming end via the second transmission channel.

15. An electronic device, comprising:
at least one processor; and
a storage apparatus for storing at least one program which, when executed by the at least one processor, causing the at least one processor to:
send, in response to a user starting a cloud game for live streaming at a live streaming end, a cloud game video stream for the cloud game to the live streaming end via a first transmission channel, wherein the cloud game video stream comprises a cloud game video frame and an identifier of the cloud game video frame;
receive a live steaming video stream for the live streaming end via a second transmission channel, wherein a live streaming video frame in the live streaming video stream is associated with the identifier;
combine the cloud game video frame and the live streaming video frame based on the identifier to generate a combined video stream; and
send the combined video stream for live streaming of the cloud game.

16. The electronic device of claim 15, wherein the at least one program causing the at least one processor to receive the live streaming video stream for the live streaming end via the second transmission channel further causes the at least one processor to:
obtain metadata for the live streaming video frame in the live streaming video stream; and
determine, from the metadata, the identifier of the cloud game video frame corresponding to the live streaming video frame.

17. The electronic device of claim 16, wherein the at least one program causing the at least one processor to receive the live streaming video stream for the live streaming end via the second transmission channel further causes the at least one processor to:
generate, in response to the live streaming video stream being received, a decoded live streaming video stream by decoding the live streaming video stream.

18. The electronic device of claim 15, wherein the at least one program causing the at least one processor to combine the cloud game video frame and the live streaming video frame based on the identifier to generate the combined video stream further causes the at least one processor to:
align the cloud game video frame with the live streaming video frame based on the identifier; and
combine the cloud game video frame and the live streaming video frame to generate the combined video stream.

19. The electronic device of claim 18, wherein the cloud game video frame is a first cloud game video frame, the identifier is a timestamp, and the at least one program causing the at least one processor to align the cloud game video frame with the live streaming video frame further causes the at least one processor to:
obtain a reference timestamp of a second cloud game video frame generated upon the live streaming video frame being received;
determine a time delay for the cloud game video frame based on the timestamp and the reference timestamp; and
align the first cloud game video frame with the live streaming video frame by delaying the first cloud game video frame by the time delay.

20. The electronic device of claim 15, wherein the at least one program causing the at least one processor to send the cloud game video stream for the cloud game to the live streaming end via the first transmission channel further causes the at least one processor to:
acquire the cloud game video frame for the cloud game;
determine the identifier of the cloud game video frame; and
send the cloud game video stream comprising the cloud game video frame and the identifier to the live streaming end via the first transmission channel.
